(19) United States
(12) Patent Application Publication
(10) Pub. No.: US 2008/0005453 A1
(43) Pub. Date: Jan. 3, 2008

(54) IMAGE FORMING APPARATUS

(76) Inventor: Tetsuhiko MIZUYAMA, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/764,429

(22) Filed: Jun. 18, 2007

(30) Foreign Application Priority Data
Jun. 19, 2006 (JP) 2006-169394

(51) Int. Cl. G06F 12/00

(52) U.S. Cl. 711/103

(57) ABSTRACT

An image forming apparatus is provided that includes a rewritable nonvolatile storage unit that has a rewrite cycle limit of a predetermined number and is configured to store changing data that change in conjunction with apparatus operations. The nonvolatile storage unit includes plural data areas for storing the changing data that are obtained by plural write operations and distributed over more than one of the data areas, an index area for storing index information that is used to determine a data area of the data areas on which a current write operation is to be performed, and a counter area for counting a number of times the data areas are rewritten which number is controlled to be not more than the rewrite cycle limit.

### BACKGROUND OF THE INVENTION

1. Field of the Invention

The present invention relates to an image forming apparatus including an EEPROM that is capable of extending the life of data retaining functions of the EEPROM.

2. Description of the Related Art

Certain electric appliances may use an EEPROM (Electrically Erasable Programmable Read Only Memory) as a nonvolatile storage unit. An EEPROM can be rewritten and is configured to retain data even when a power supply is cut off. However, there is a limit to the number of times data may be rewritten on the EEPROM (referred to as “rewrite cycle limit” hereinafter). An image forming apparatus such as a copier or a printer may use the EEPROM to retain data that are based on adjustment value data used in image forming operations (e.g., see Japanese Laid-Open Patent Publication No. 2006-30929).

According to Japanese Laid-Open Patent Publication No. 2006-30929, by providing a nonvolatile storage unit such as an EEPROM within a frame that accommodates replaceable parts and devices and having the nonvolatile storage unit store corresponding life information of the replaceable parts and devices, determinations may be made as to whether the replaceable parts and devices within the frame have reached the ends of their service lives based on their corresponding life information so that replacement operations may be facilitated.

However, there is a limit to the number of times data may be rewritten on the EEPROM and when the number of rewrites performed on the EEPROM exceeds this limit, the accuracy of updated data values obtained thereafter may not be ensured and errors may occur in operations such as image forming operations that rely on adjustment value data, for example.

### SUMMARY OF THE INVENTION

One aspect of the present invention is directed to providing an image forming apparatus that is capable of extending the life of data retaining functions of an EEPROM while ensuring the accuracy of retained data.

According to one embodiment of the present invention, an image forming apparatus is provided that includes:

a rewritable nonvolatile storage unit that has a rewrite cycle limit of a predetermined number and is configured to store changing data that change in conjunction with apparatus operations, the nonvolatile storage unit including

plural data areas for storing the changing data that are obtained by plural write operations and distributed over more than one of the data areas;

an index area for storing index information that is used to determine a data area of the data areas on which a current write operation is to be performed; and

a counter area for counting a number of times the data areas are rewritten which number is controlled to be not more than the rewrite cycle limit.

According to another embodiment of the present invention, an image forming apparatus is provided that includes:

a rewritable nonvolatile storage unit that has a rewrite cycle limit of a predetermined number and is configured to store changing data that change in conjunction with apparatus operations, the nonvolatile storage unit including a data area for storing the changing data that are obtained by plural write operations and a counter area for counting a number of times the data area is rewritten; and

a random access memory that includes a temporary recording data area for temporarily storing the changing data and a temporary recording counter area for counting a number of times the temporary recording data area is rewritten and determining a timing for writing the changing data stored in the temporary recording data area in the data area of the nonvolatile storage unit.

In one preferred embodiment, the image forming apparatus of the present invention may include a network communication unit that is connected to a network and is configured to inform a service center via the network that a service life of the nonvolatile storage unit is nearing an end when the number of times the data area of the is rewritten is close to reaching the rewrite cycle limit.

In another preferred embodiment, the image forming apparatus of the present invention may include a display monitor configured to indicate when the number of times the data area is rewritten reaches the rewrite cycle limit.

In another preferred embodiment, the image forming apparatus of the present invention may include a network communication unit that is connected to a network and is configured to convey information via the network that a service life of the nonvolatile storage unit has reached an end when the number of times the data area is rewritten reaches the rewrite cycle limit.

In another preferred embodiment, the image forming apparatus of the present invention may include a display monitor configured to be used for setting the rewrite cycle limit of the nonvolatile storage unit.

In another preferred embodiment, the image forming apparatus of the present invention may include a display monitor configured to be used for resetting the number of times the data area is rewritten that is stored in the counter area of the nonvolatile storage unit.

### BRIEF DESCRIPTION OF THE DRAWINGS

FIG. 1 is a block diagram showing overall board configurations of a controller and an engine that are included in an image forming apparatus according to an embodiment of the present invention;

FIG. 2 is a plan view of a display monitor that is included in an image forming apparatus according to a first embodiment of the present invention;

FIG. 3 is a table illustrating a configuration of adjustment value data stored in the image forming apparatus according to the first embodiment;

FIG. 4 is a table illustrating a map of areas storing the adjustment value data of the first embodiment;

FIG. 5 is a diagram illustrating a relationship between data areas, index areas, and a counter area of an EEPROM of the image forming apparatus according to the first embodiment;

FIG. 6 is a flowchart illustrating operation procedures for updating data according to the first embodiment;

FIG. 7 is a plan view of a display monitor included in an image forming apparatus according to a second embodiment of the present invention;

FIG. 8 is a table illustrating a configuration of adjustment value data stored in the image forming apparatus according to the second embodiment;

FIG. 9 is a diagram illustrating a relationship between a temporary recording data area and a temporary recording counter area of a RAM and a data area and a counter area of an EEPROM of the image forming apparatus according to the second embodiment; and

FIG. 10 is a flowchart illustrating operation procedures for updating data according to the second embodiment.

### DESCRIPTION OF THE PREFERRED EMBODIMENTS

In the following, preferred embodiments of the present invention are described with reference to the accompanying drawings.

### Embodiment 1

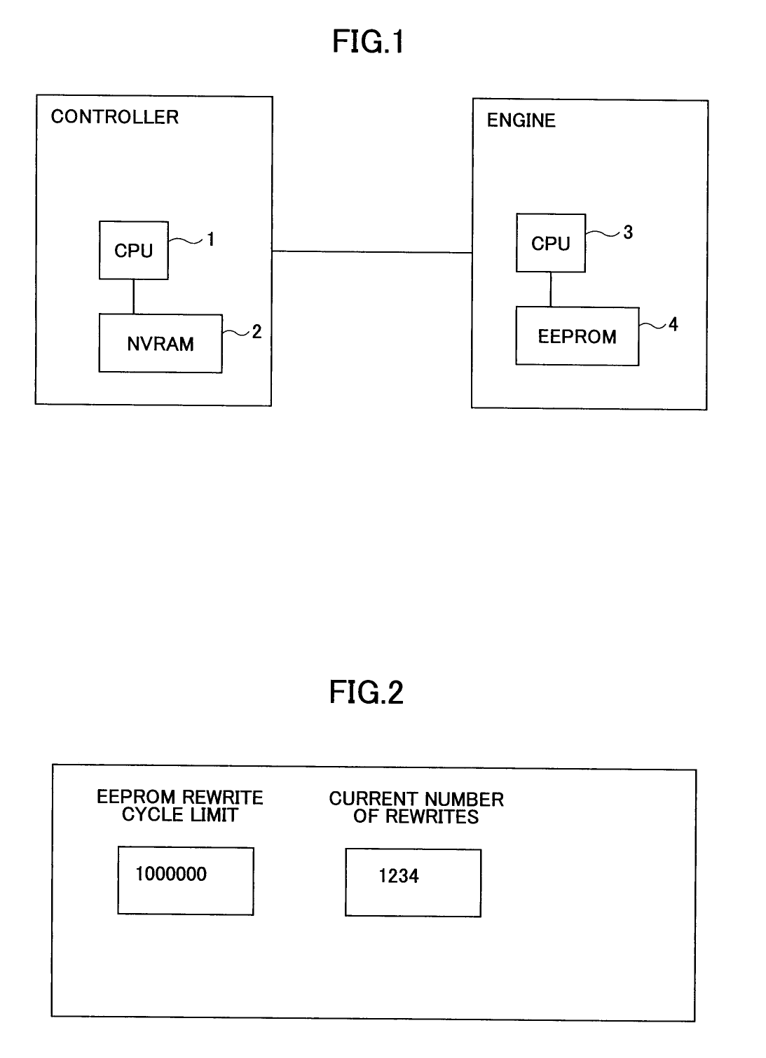

FIG. 1 is a block diagram showing overall board (circuit substrate) configurations of a controller and an engine that are included in an image forming apparatus according to an embodiment of the present invention. As is shown in FIG. 1, the controller board includes a CPU 1 and a NVRAM (Nonvolatile Random Access Memory) 2, and the engine board includes a CPU 3 and an EEPROM (Electrically Erasable Programmable Read Only Memory) 4 as an embodiment of a rewritable nonvolatile storage unit. The NVRAM 2 is capable of retaining data even when a power supply is cut off as long as the power of its internal battery remains.

The EEPROM 4 may be rewritten and is capable of retaining data even after a power supply is cut off. However, there is a limit to the number of times data may be rewritten on the EEPROM 4 which number may range from several hundred thousand to a million times, for example (referred to as “rewrite cycle limit” hereinafter). Upon rewriting the EEPROM 4, all the bit data of a data area have to be erased even when only a portion of the data needs to be rewritten. That is, random data read/write operations that are performed on a RAM cannot be performed on the EEPROM 4. It is noted that the EEPROM 4 that is included in an image forming apparatus according to an embodiment of the present invention is used for storing data that are frequently rewritten such as the number of prints or the operating time of expendable parts, for example.

FIG. 2 is a plan view of a display monitor that is used in an image forming apparatus according to a first embodiment of the present invention. The display monitor may be used for checking the current number of rewrites performed on the EEPROM 4, customizing the rewrite cycle limit for the EEPROM 4, and resetting the count value of the current number of rewrites performed on the EERPOM 4 (even when the count value has not reached the rewrite cycle limit), for example. In a preferred embodiment, when the number of rewrites performed on the EEPROM 4 reaches the rewrite cycle limit, this may be indicated on the display monitor. In another preferred embodiment, when the number of rewrites performed on the EEPROM 4 is close to reaching the rewrite cycle limit, a service center may be informed of such a situation via a network. In another preferred embodiment, when the number of rewrites performed on the EEPROM 4 reaches the rewrite cycle limit, such information may be conveyed via a network.

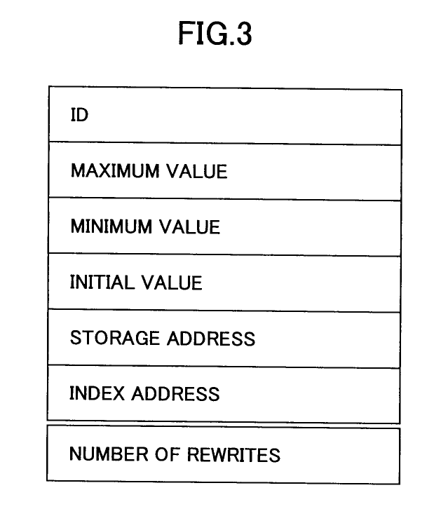

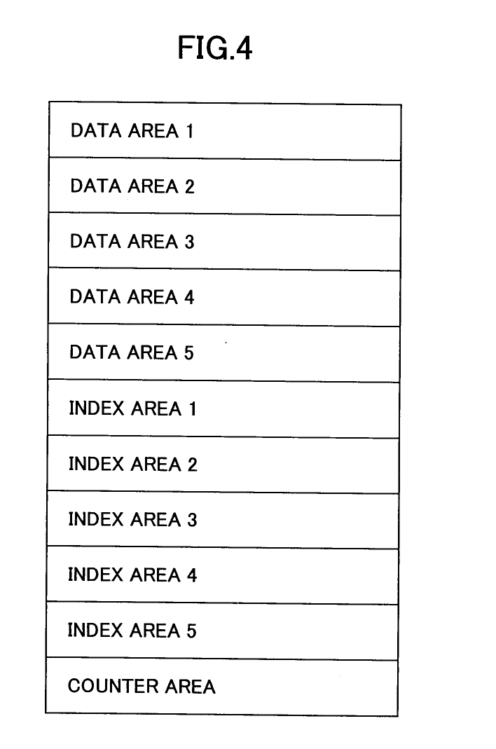

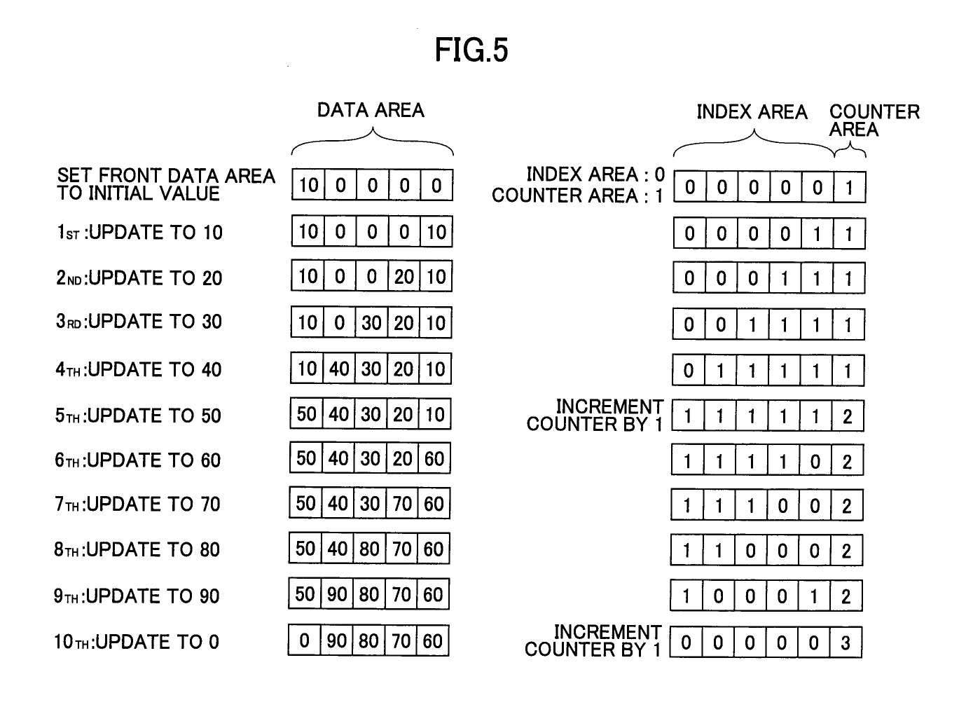

FIG. 3 is a table illustrating a configuration of adjustment value data as an embodiment of changing data that change in conjunction with operations of the image forming apparatus. The illustrated adjustment value data are used in image forming operations and each set of the adjustment value data may include information items representing an ID, a maximum value, a minimum value, an initial value, a storage address, an index address, and a number of rewrites. It is noted that in some cases, the number of adjustment value data sets used in the image forming apparatus may exceed 3000 depending on the type of apparatus. FIG. 4 is a table illustrating a map of areas of the EEPROM 4 used for storing the adjustment value data. The areas for storing the adjustment value data include three types of areas, namely, a data area, an index area, and a counter area. In the present embodiment, plural data areas (five data areas in the illustrated example of FIG. 4) that store the adjustment value data are provided. In this case, if one data area of the EEPROM 4 can be rewritten up to 1 million times, a total of up to 5 million write operations may be performed on the plural data areas. It is noted that in the present embodiment, plural areas are used for storing adjustment value data that are frequently rewritten (updated). On the other hand, one fixed data area may be used for storing adjustment data that are not updated so frequently.

The index area is used for determining the data area on which a current write operation (data updating operation) is to be performed, the details of which are described below with reference to FIG. 5. The counter area is used for counting the number of times the data areas of the EEPROM 4 are rewritten. Specifically, a counter value stored in the counter area may be updated when all values of the index areas are set to “1” or when all values of the index areas are set to “0”, for example. According to one example as is illustrated in FIG. 5, the value of a data area at the front end may be set to an initial value, and the values of the data areas may be successively rewritten thereafter from the rear end in conjunction with data updating operations. In this example, the count value of the counter area is set to “1” when the value of the data area at the front end is set to the initial value. Then, the count value of the counter area is set to “2” at the time a fifth data updating operation (write operation) is performed from which point the data areas of the EEPROM 4 are to be rewritten for a second time. Then, the count value of the counter area is set to “3” at the time a tenth data updating operation is performed from which point the data areas of the EEPROM 4 are to be rewritten for a third time. In this way, data updating operations may be performed up to 5 million times while each of the data areas of the EEPROM 4 are rewritten up to 1 million times, for example.

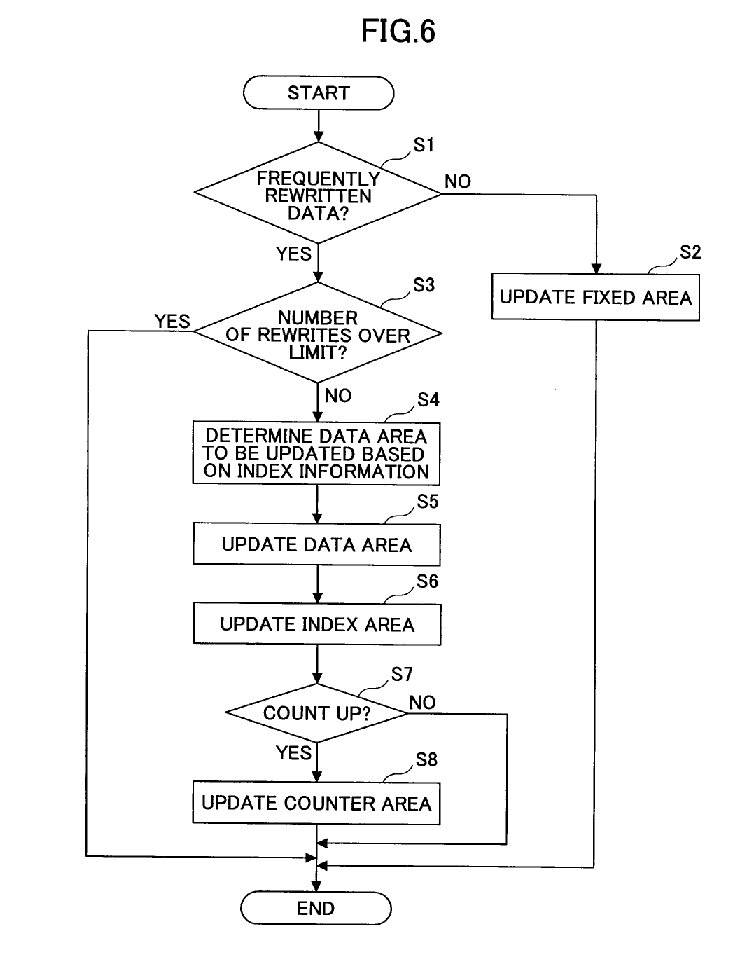

FIG. 6 is a flowchart illustrating operation procedures for updating data of the EEPROM 4 according to the first embodiment.

As is shown in this drawing, when a data updating operation is started in response to an updating request, a determination is made as to whether the data to be updated corresponds to frequently rewritten data (step S1). If it is determined that the data are not frequently rewritten, a corresponding fixed area is updated (rewritten) after which the operation is ended. If it is determined that the data are frequently rewritten, a determination is made as to whether the current number of rewrites (number of time the data areas of the EEPROM 4 are rewritten) is over the limit (step S3). If it is determined that the current number of rewrites is over the limit (step S3, YES), the data updating operation is ended without updating the data of the EEPROM 4.

If the current number of rewrites is not over the limit (step S3, NO), a data area to be updated is determined based on index information stored in the index areas (step S4), and the determined data area is updated (step S5). Then, in response to such data updating, value data (index information) of the index areas are updated (step S6). Then, a determination is made as to whether the count value of the counter area representing the number of times the data areas have been rewritten is to be updated (counted up) based on the index information stored in the index areas (step S7). In the present example, the count value of the counter area is updated (counted up) when all the values of the index areas are set to “0” or all the values of the index areas are set to “1” as is shown in FIG. 5 (step S8). On the other hand, when it is determined that the count up timing has not yet been reached, the data updating operation is ended without updating the count value of the counter area.

As can be appreciated from the above descriptions, in the image forming apparatus according to the first embodiment, the EEPROM 4 that has a rewrite cycle limit of a predetermined number and is configured to store changing data such as adjustment value data that change in conjunction with operations of the image forming apparatus includes plural data areas for storing the changing data that are obtained by a plurality of write operations and distributed over more than one of the data areas (a data area has to be rewritten plural times to store the changing data in a case where only one data area is provided); an index area for storing index information that is used to determine the data area on which a current write operation is to be performed; and a counter area for counting a number of times the data areas are rewritten which number is controlled to be not more than the rewrite cycle limit. In this way, the life of the data retaining functions of the EEPROM 4 may be extended while ensuring the accuracy of the data stored in the EEPROM 4.

In a preferred embodiment, the display monitor may indicate when the number of times the data areas of the EEPROM are rewritten exceeds the rewrite cycle limit so that a user may be informed of such a situation, for example. In another preferred embodiment, the display monitor may be used to set the rewrite cycle limit of the EEPROM 4 so that usability of the image forming apparatus may be improved, for example. In another preferred embodiment, the display monitor may be used to reset the number of times the data areas have been rewritten that is stored in the counter area of the EEPROM 4 even when the number has not yet reached the rewrite cycle limit so that debugging by a programmer may be effectively implemented, for example.

In another preferred embodiment, when the number of rewrites performed on the EEPROM 4 is close to reaching the rewrite cycle limit, such information may be communicated to a service center via a network so that the EEPROM 4 may be replaced before it reaches its life end, for example. In another preferred embodiment, when the number of times the data areas of the EEPROM 4 are rewritten reaches the rewrite cycle limit, such information may be conveyed via a network to signal the replacement timing of the EEPROM 4, for example.

### Embodiment 2

In the following, an image forming apparatus according to a second embodiment is described. It is noted that components of the image forming apparatus according to the present embodiment that are identical to those of the image forming apparatus according to the first embodiment are given the same reference numerals and their descriptions are omitted.

As is the case with the first embodiment, the image forming apparatus according to the second embodiment includes a controller board with a CPU 1 and a NVRAM 2, and an engine board with a CPU 3 and an EEPROM 4 (see FIG. 1). The EEPROM 4 is used to store data that are frequently updated such as the number of prints or the operating time of expendable parts.

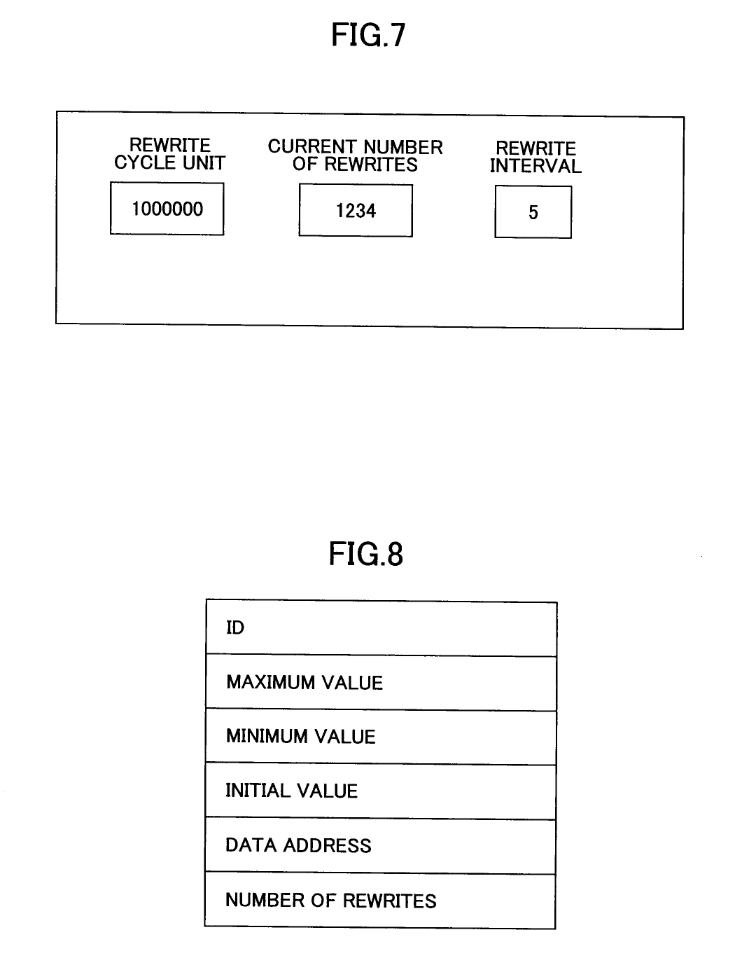

FIG. 7 is a plan view of a display monitor used in the image forming apparatus according to the second embodiment. The illustrated display monitor may be used for checking the number of times data have been rewritten on the EEPROM 4, customizing the rewrite cycle limit, and resetting the rewrite count value of the EEPROM 4 (even when the count value has not yet reached the rewrite cycle limit), for example. In one preferred embodiment, the display monitor may be used for setting/displaying a temporary recording data area rewrite count value that is referred to upon writing data on the data area of the EEPROM 4 as is described in detail below. In another preferred embodiment, when the number of times the data area of the EEPROM 4 is rewritten reaches the rewrite cycle limit, an indication may be displayed on the display monitor. In another preferred embodiment, the image forming apparatus according to the second embodiment may have network communication functions similar to those provided in the image forming apparatus according to the first embodiment.

FIG. 8 is a table illustrating a configuration of adjustment value data stored in the image forming apparatus according to the second embodiment. As is shown in this drawing, each set of adjustment value data may include information items representing an ID, a maximum value, a minimum value, an initial value, a data address, and a write count address. In the present embodiment, a map of areas storing the adjustment value data is made up of two types of areas, namely, a data area and a counter area. The data area is for storing the adjustment value data. In the present embodiment, one single fixed area is provided as the data area of the EEPROM 4 used for writing the adjustment value data even when the adjustment data have to be frequently rewritten. As can be appreciated from the descriptions below, according to the present embodiment, in a case where the data area of the EEPROM can be rewritten up to 1 million times, adjustment value data to be stored in the EEPROM 4 may be rewritten (updated) up to 5 million times, for example.

The image forming apparatus according to the second embodiment includes a RAM having a temporary recording data area for temporarily storing data that are frequently updated (i.e., data that are obtained by plural write operations are temporarily stored in the temporary recording data area instead of directly writing the data in the data area of the EEPROM 4) and a temporary recording counter area that counts the number of times data are rewritten in the temporary recording data area to determine the timing for writing the data in the data area of the EEPROM 4.

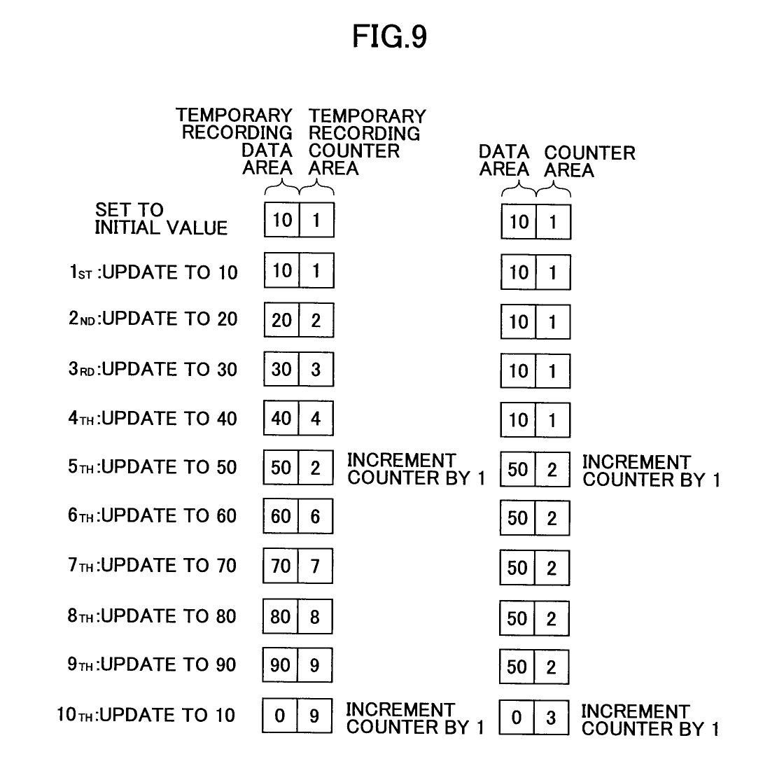

FIG. 9 is a diagram illustrating the relationship between the temporary recording data area and the temporary recording counter area of the RAM and the data area and the counter area of the EEPROM 4 used in the image forming apparatus according to the present embodiment. In the following, exemplary write operations performed on the EEPROM 4 are described with reference to this drawing. In the present example, the number of times the temporary recording data area have to be rewritten before the data stored in the temporary recording data area may be written in the data area of the EEPROM 4 is set to five (see “rewrite interval” of FIG. 7).

As is shown in FIG. 9, first, data are written in the data area of the EEPROM 4 and an initial value of “1” is written in the counter area of the EEPROM 4 as the number of times the data area of the EEPROM 4 has been rewritten. Then, the data written in the data area and counter area of the EEPROM 4 are respectively written in the temporary recording data area and temporary recording counter area of the RAM. Then, when the temporary recording data area is to be rewritten for the fifth time (fifth write operation), the data to be written in the temporary recording data area in the fifth write operation are written in the data area of the EEPROM 4 and the counter value of the counter area of the EEPROM 4 is incremented by one to be set to “2”. The same data that are written in the data area and the counter area of the EEPROM 4 are written in the temporary recording data area and the temporary recording counter area of the RAM. Then, when the temporary recording data area of the RAM are to be rewritten for the tenth time (tenth write operation), the data to be written in the temporary recording data area in the tenth write operation are written in the data area of the EEPROM 4 and the counter value of the counter area of the EEPROM 4 is incremented by one to be set to “3”. The same data that are stored in the data area and the counter area of the EEPROM 4 are written in the temporary recording data area and the temporary recording counter area of the RAM.

It is noted that in the present example, the data area of the EEPROM 4 is rewritten once with respect to every five write operations performed on the temporary recording data area of the RAM so that in the case where the EEPROM 4 has a rewrite cycle limit of 1 million, data may actually be rewritten up to 5 million times. It is noted that although the number of times the temporary recording data area of the RAM is to be rewritten between each rewrite operation of the data area of the EEPROM 4 (rewrite interval) is set to five in the above-described example, the present invention is not limited to such an example, and the rewrite interval may be set to any suitable number N so that data may be rewritten up to N times the rewrite cycle limit of the EEPROM 4.

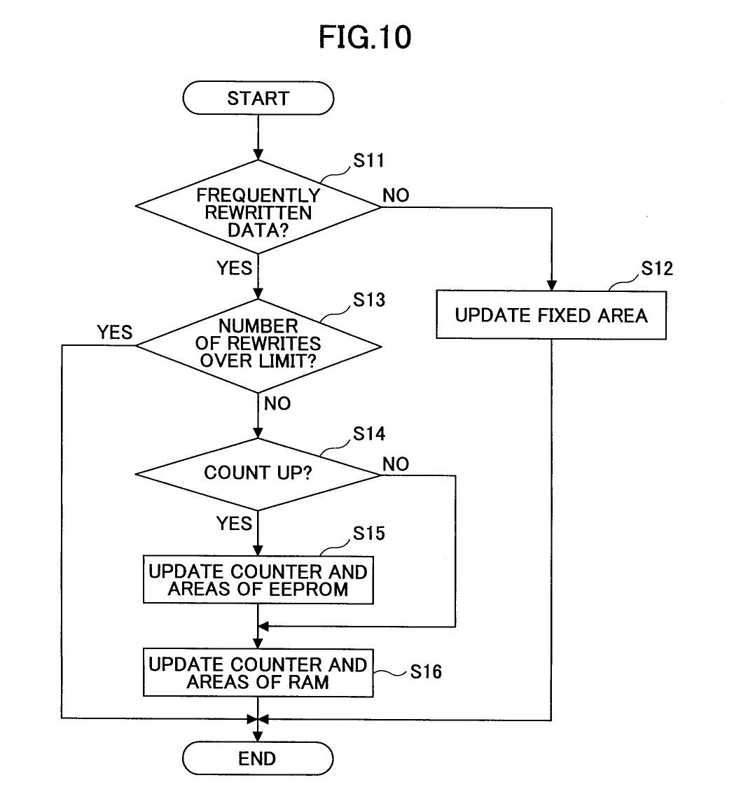

FIG. 10 is a flowchart illustrating exemplary operation procedures for updating data in the image forming apparatus according to the second embodiment.

As is shown in this drawing, when a data updating operation is started in response to a data updating request, a determination is made as to whether the data to be updated corresponds to frequently rewritten data (step S11). If it is determined that the data is not frequently rewritten, the data are written in a corresponding fixed area and the data updating operation is ended. If it is determined that the data are frequently rewritten, a determination is made as to whether the current number of rewrites (number of times the data area of the EEPROM 4 is rewritten) exceeds the limit (step S13). If the current number of rewrites exceeds the limit, the data updating operation is ended without updating the EEPROM 4. If the current number of rewrites does not exceed the limit, a determination is made as to whether the counter value of the counter area of the EEPROM 4 is to be counted up (step S14).

In determining whether the count value of the counter area of the EEPROM 4 is to be counted up, if the number of times the temporary recording data area of the RAM has been rewritten is a multiple of a preset value representing the rewrite interval (i.e., number of times the temporary recording data area of the RAM is to be rewritten between each rewrite operation of the EEPROM 4), a positive determination is made and the data and the counter value of the EEPROM 4 are updated (step S15). Then, the data and the counter value of the RAM are also updated (step S16) and the data updating operation is ended. When it is determined in step S14 that the counter value of the EEPROM 4 does not have to be counted up, the operation moves on to step S16 where the data and the counter value of the RAM are updated after which the operation is ended.

As can be appreciated, the image forming apparatus according to the second embodiment includes a RAM that is made up of a temporary recording data area and a temporary recording counter area where the temporary recording data area is for temporarily storing data that are rewritten plural times before being written in the data area of the EEPROM 4 (i.e., the data are written plural times in the temporary recording data instead of being directly written in the data area of the EEPROM 4), and the temporary recording counter area is for counting the number of times the temporary recording data area has been rewritten to determine the timing for writing the data stored in the temporary recording data area in the data area of the EEPROM 4. In this way, the life of data retaining functions of the EEPROM 4 may be extended without increasing the capacity of the EEPROM 4 while ensuring the accuracy of the retained data, for example.

In a preferred embodiment, the display monitor may indicate when the service life of the EEPROM 4 has reached an end so that a user may be informed of such a situation, for example. In another preferred embodiment, the display monitor may be used for setting of the rewrite cycle limit of the EEPROM 4 so that usability of the image forming apparatus may be improved, for example. In another preferred embodiment, the display monitor may be used for resetting the rewrite count value stored in the counter area of the EEPROM 4 even when the counter value has not yet reached the rewrite cycle limit so that debugging by a programmer may be effectively implemented, for example. In another preferred embodiment, when the EEPROM 4 is close to reaching the end of its life, such a situation may be signaled to a service center via a network so that the EEPROM 4 may be replaced before it reaches its life end, for example. In another preferred embodiment, when the EEPROM 4 reaches the end of its service life, such information may be conveyed via a network to signal the replacement timing of the EEPROM 4, for example.

Although the present invention is shown and described with respect to certain preferred embodiments, it is obvious that equivalents and modifications may occur to others skilled in the art upon reading and understanding the specification. The present invention includes all such equivalents and modifications, and is limited only by the scope of the claims.

The present application is based on and claims the benefit of the earlier filing date of Japanese Patent Application No. 2006-169394 filed on Jun. 19, 2006, the entire contents of which are hereby incorporated by reference.

What is claimed is:

1. An image forming apparatus comprising:
a rewritable nonvolatile storage unit that has a rewrite cycle limit of a predetermined number and is configured to store changing data that change in conjunction with apparatus operations, the nonvolatile storage unit including
a plurality of data areas for storing the changing data that are obtained by a plurality of write operations and distributed over more than one of the data areas;
an index area for storing index information that is used to determine a data area of the data areas on which a current write operation is to be performed; and
a counter area for counting a number of times the data areas are rewritten which number is controlled to be not more than the rewrite cycle limit.

2. The image forming apparatus as claimed in claim 1, further comprising:
a network communication unit that is connected to a network and is configured to inform a service center via the network that a service life of the nonvolatile storage unit is nearing an end when the number of times the data areas are rewritten is close to reaching the rewrite cycle limit.

3. The image forming apparatus as claimed in claim 1, further comprising:
a display monitor configured to indicate when the number of times the data areas are rewritten reaches the rewrite cycle limit.

4. The image forming apparatus as claimed in claim 2, further comprising:
a display monitor configured to indicate when the number of times the data areas are rewritten reaches the rewrite cycle limit.

5. The image forming apparatus as claimed in claim 1, further comprising:
a network communication unit that is connected to a network and is configured to convey information via the network that a service life of the nonvolatile storage unit has reached an end when the number of times the data areas are rewritten reaches the rewrite cycle limit.

6. The image forming apparatus as claimed in claim 2, further comprising:
a network communication unit that is connected to a network and is configured to convey information via the network that a service life of the nonvolatile storage unit has reached an end when the number of times the data areas are rewritten reaches the rewrite cycle limit.

7. The image forming apparatus as claimed in claim 1, further comprising:
a display monitor configured to be used for setting the rewrite cycle limit of the nonvolatile storage unit.

8. The image forming apparatus as claimed in claim 2, further comprising:
a display monitor configured to be used for setting the rewrite cycle limit of the nonvolatile storage unit.

9. The image forming apparatus as claimed in claim 1, further comprising:
a display monitor configured to be used for resetting the number of times the data areas are rewritten that is stored in the counter area of the nonvolatile storage unit.

10. The image forming apparatus as claimed in claim 2, further comprising:
a display monitor configured to be used for resetting the number of times the data areas are rewritten that is stored in the counter area of the nonvolatile storage unit.

11. An image forming apparatus comprising:
a rewritable nonvolatile storage unit that has a rewrite cycle limit of a predetermined number and is configured to store changing data that change in conjunction with apparatus operations, the nonvolatile storage unit including a data area for storing the changing data that are obtained by a plurality of write operations and a counter area for counting a number of times the data area is rewritten; and
a random access memory that includes a temporary recording data area for temporarily storing the changing data and a temporary recording counter area for counting a number of times the temporary recording data area is rewritten and determining a timing for writing the changing data stored in the temporary recording data area in the data area of the nonvolatile storage unit.

12. The image forming apparatus as claimed in claim 11, further comprising:
a network communication unit that is connected to a network and is configured to inform a service center via the network that a service life of the nonvolatile storage unit is nearing an end when the number of times the data area of the is rewritten is close to reaching the rewrite cycle limit.

13. The image forming apparatus as claimed in claim 11, further comprising:
a display monitor configured to indicate when the number of times the data area is rewritten reaches the rewrite cycle limit.

14. The image forming apparatus as claimed in claim 12, further comprising:
a display monitor configured to indicate when the number of times the data area is rewritten reaches the rewrite cycle limit.

15. The image forming apparatus as claimed in claim 11, further comprising:
a network communication unit that is connected to a network and is configured to convey information via the network that a service life of the nonvolatile storage unit has reached an end when the number of times the data area is rewritten reaches the rewrite cycle limit.

16. The image forming apparatus as claimed in claim 12, further comprising:
a network communication unit that is connected to a network and is configured to convey information via the network that a service life of the nonvolatile storage unit has reached an end when the number of times the data area is rewritten reaches the rewrite cycle limit.

17. The image forming apparatus as claimed in claim 11, further comprising:
a display monitor configured to be used for setting the rewrite cycle limit of the nonvolatile storage unit.

18. The image forming apparatus as claimed in claim 12, further comprising:
a display monitor configured to be used for setting the rewrite cycle limit of the nonvolatile storage unit.

19. The image forming apparatus as claimed in claim 11, further comprising:
a display monitor configured to be used for resetting the number of times the data area is rewritten that is stored in the counter area of the nonvolatile storage unit.

20. The image forming apparatus as claimed in claim 12, further comprising:
a display monitor configured to be used for resetting the number of times the data area is rewritten that is stored in the counter area of the nonvolatile storage unit.
